(19) United States
(12) Patent Application Publication
(10) Pub. No.: US 2007/0145169 A1
(43) Pub. Date: Jun. 28, 2007

(54) Food Waste Disposer

(75) Inventors: Steven P. Hanson, Racine, WI (US); Thomas R. Berger, Racine, WI (US); Nicholas J. Hirsch, Racine, WI (US); Yasuhiro Iwata, Racine, WI (US); Motoya Oghino, Racine, WI (US)

Correspondence Address: LOCKE LIDDELL & SAPP LLP;ATTN: IP DOCKETING, 600 TRAVIS STREET, 3400 CHASE TOWER, HOUSTON, TX, 77002, US

(73) Assignee: EMERSON ELECTRIC CO., St. Louis, MO (US)

(21) Appl. No.: 11/564,590

(22) Filed: Nov. 29, 2006

Related U.S. Application Data
(62) Division of application No. 10/709,842, filed on Jun. 1, 2004.
(60) Provisional application No. 60/474,477, filed on May 30, 2003.
(60) Provisional application No. 60/481,490, filed on Oct. 9, 2003.

(51) Int. Cl. B02C 23/36

(52) U.S. Cl. 241/46.013

(57) ABSTRACT

A food waste disposer includes a food conveying section, a grinding mechanism, and a brushless permanent magnet motor operably connected to the grinding mechanism. A discharge device is configured so as to reduce the overall height of the food waste disposer.

### CROSS REFERENCE TO RELATED APPLICATIONS

The present application is a divisional of co-pending U.S. patent application Ser. No. 10/708,842 filed Jun. 1, 2004, which claims the benefit of priority to U.S. Provisional Application Ser. Nos. 60/474,477 and 60/481,490, filed May 30, 2003, and Oct. 9, 2003, respectively, the contents of all of which are incorporated by herein by reference.

### BACKGROUND

The present disclosure relates generally to food waste disposers.

A typical food waste disposer includes a food conveying section, a motor section and a central grinding section disposed between the food conveying section and the motor section. The food conveying section conveys the food waste to the central grinding section, which typically has a shredder plate that is rotated by the motor relative to a stationary grind ring. Lugs, which may be stationary (fixed lugs) or free to rotate (swivel lugs), are attached to the shredder plate.

The stationary grind ring, which includes a plurality of spaced teeth, is fixedly attached to an inner surface of the grinding section housing. In the operation of the food waste disposer, the food waste delivered by the food conveying section to the grinding section is forced by the lugs against the teeth of the grind ring as the shredder plate is rotated by the motor. The teeth grind the food waste into particulate matter sufficiently small to pass from above the shredder plate to a discharge chamber located below the stationary grind ring and shredder plate.

Conventional food waste disposers often use an induction motor to drive the rotating shredder plate. Known alternatives to induction motors include switch reluctance motors and brushed permanent magnet motors. It is desirable to minimize the amount of under-sink space occupied by a disposer to increase the useable area under the sink, and to decrease the disposer weight. However, due at least in part to the size of the motors used in known food waste disposers, the vertical height of known disposers (the distance between the inlet and the bottom of the motor section) may be larger than is desired.

The present invention addresses shortcomings associated with the prior art.

### SUMMARY

A food waste disposer and associated method are disclosed herein. The food waste disposer includes a food conveying section, a grinding mechanism, and a motor operably connected to the grinding mechanism. In certain exemplary embodiments, a brushless permanent magnet (BPM) motor is employed to operate the grind mechanism. A discharge chamber generally surrounds the grinding mechanism. Among other things, the configuration of the discharge chamber reduces the profile (vertical height) of the disposer.

In disclosed exemplary embodiments, the grind mechanism includes a shredder plate that is rotatable by the motor and a stationary grind ring. Lugs are attached to the shredder plate to force food waste against or through the grind ring. The shredder plate defines a plane, and at least a portion of the discharge chamber is located above the plane, rather than being entirely below the shredder plate. The discharge chamber defines a discharge port, and a portion of the discharge port is located above the plane.

The discharge chamber and the grind ring define a gap therebetween, which defines a cross-sectional area that increases from a first location to a discharge port at the end of the discharge chamber.

### BRIEF DESCRIPTION OF DRAWINGS

Other objects and advantages of the invention will become apparent upon reading the following detailed description and upon reference to the drawings in which:

FIG. 1 is a perspective view of an exemplary food waste disposer.

FIG. 2 is a side view thereof.

FIG. 3 is a front view thereof.

FIG. 4 is a sectional view thereof, taken along line 4-4 of FIG. 3.

FIG. 5 is a top view thereof.

FIG. 6 is a perspective view thereof, showing the disposer with the top section removed to illustrate the grinding and discharge sections of the disposer.

FIG. 7 shows an internal magnet rotor for the brushless permanent magnet motor of the disclosed food waste disposer.

FIG. 8 shows a stator for the for the brushless permanent magnet motor of the disclosed food waste disposer.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers” specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

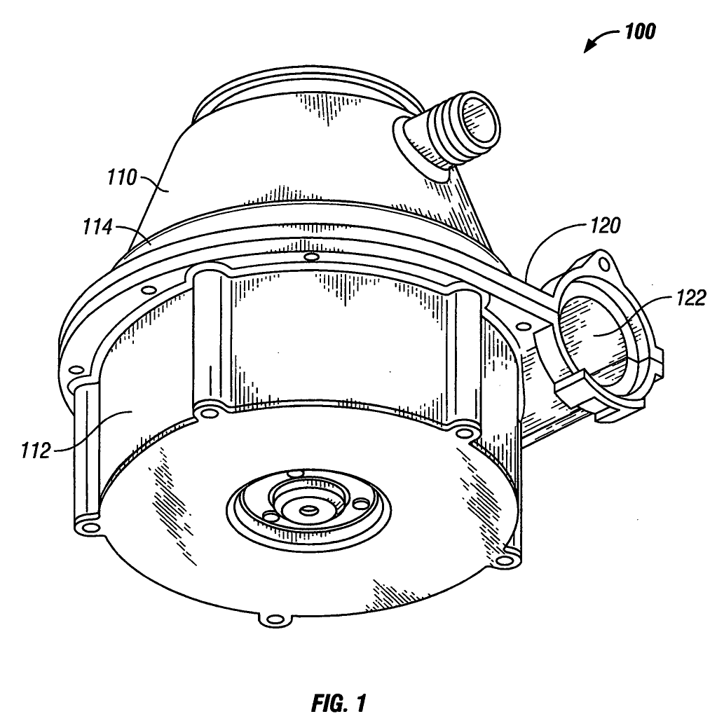

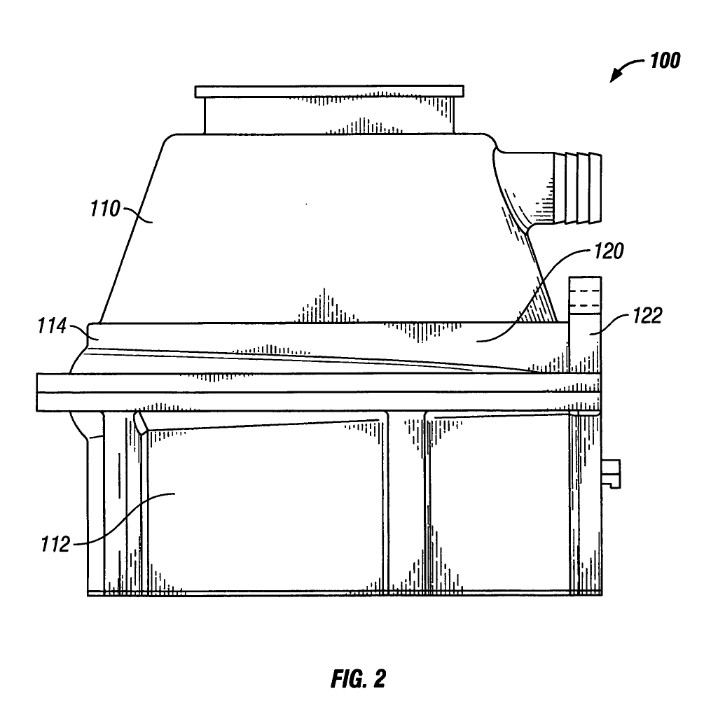

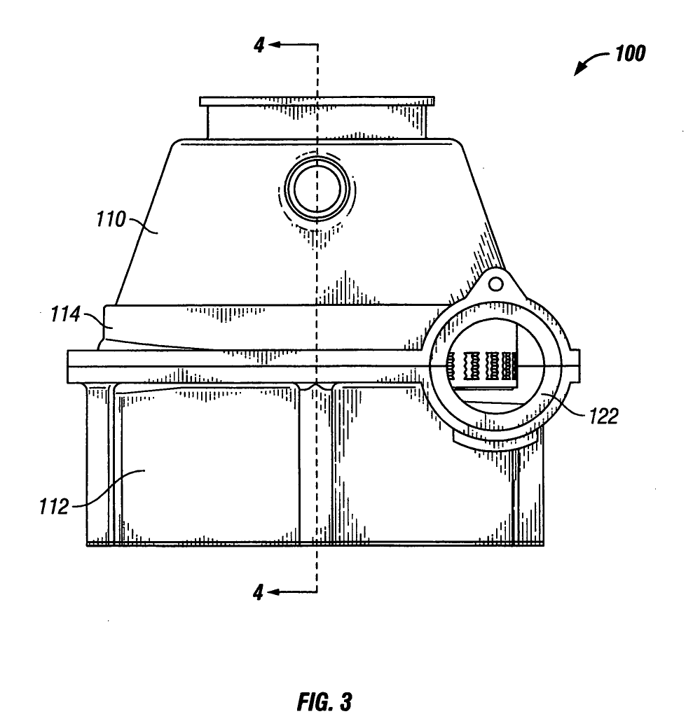

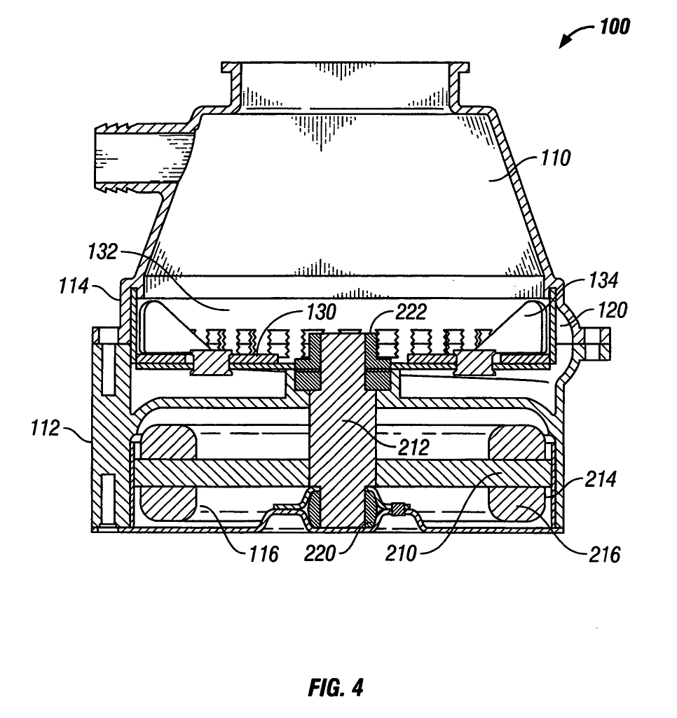

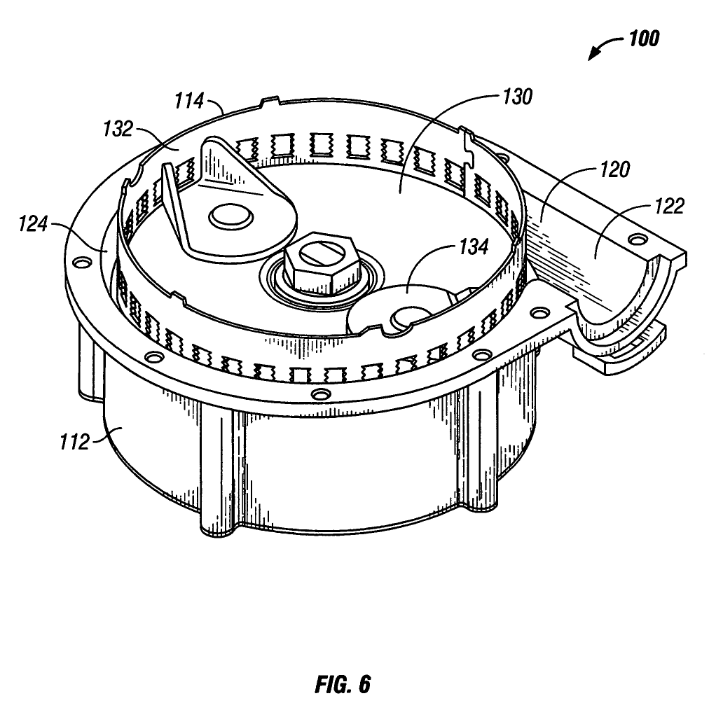

FIGS. 1-6 show various views of an exemplary food waste disposer 100 having a reduced vertical height, or profile. The low profile disposer 100 has a food conveying section 110, a motor housing 112 and a grinding mechanism 114. The food conveying section conveys 110 the food waste to the grinding section 114, which includes a rotatable shredder plate 130 and a stationary grind ring 132. In the illustrated embodiment, swivel lugs 134 are attached to the shredder plate 130. In other embodiments, fixed lugs may be employed. The motor section 112 includes a motor 116 that rotates the shredder plate 130.

Unlike known disposers, the disclosed device 100 uses a discharge chamber 120 that generally surrounds the grinding mechanism 114. The discharge chamber 120 ends with a discharge port 122 through which waste exits the disposer 100. In the illustrated embodiment, the discharge chamber 120 is located outside, rather than below, the stationary grind ring 132. In the illustrated embodiment, the rotating shredder plate 130 generally defines a horizontal plane, and the discharge chamber 120 and discharge port 122 are situated such that a portion thereof is located above the plane defined by the rotating shredder plate 130. In known disposers, the discharge port is located entirely below the grinding mechanism, including the rotating shredder plate and stationary grind ring.

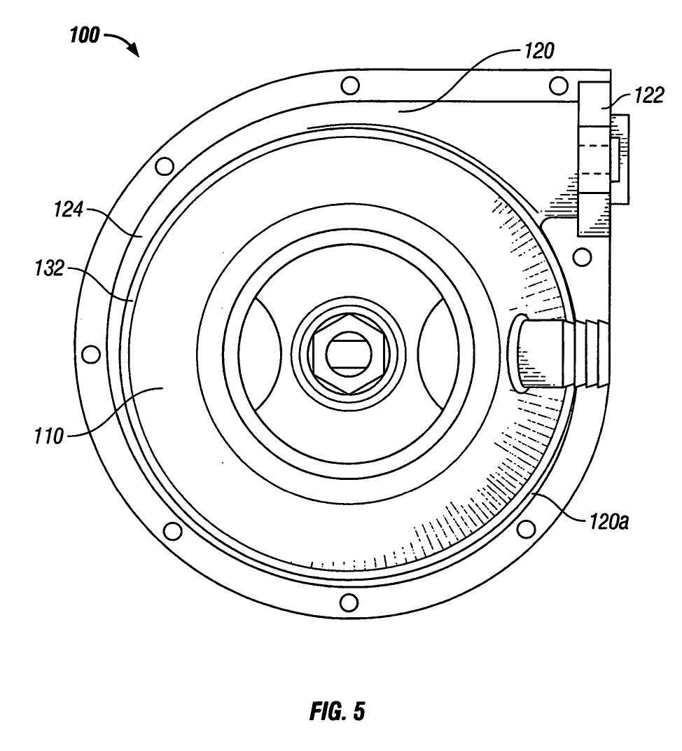

The configuration of the discharge chamber 120 allows the rotating shredder plate 130 to add velocity to the waste stream by centrifugal force. The discharge chamber 120 defines a cross-sectional area that increases from the beginning of the chamber 120a to the discharge port 122. The drawings (best seen in FIG. 5) show a gap 124 between the back of the grind ring 132 and the discharge chamber 120 that increases in a clockwise direction (which is also the direction of the motor rotation in the illustrated embodiment). The increasing gap 124 causes a progressively larger amount of discharge to be accumulated in the discharge port 122 as the material exits the disposer. This configuration helps to increase the amount and speed of waste discharged (similar to a turbocharger horn). This configuration also helps to reduce the pressure differences present in the discharge solution as it exits the disposer 100 thereby reducing unwanted vibrations.

The motor housing 112 incorporates the discharge chamber 120 and components of the grinding mechanism 114. Unlike current disposers, this design incorporates additional functionality to the motor housing. In order to reduce the overall height of the disposer, part of the discharge chamber 120 and grinding components 114 are contained in the motor housing 114, rather than require an additional discharge section situated between the motor and the grinding mechanism. This is possible because of the way the discharge chamber 114 is constructed. Beside the benefit of a lower profile disposer, this allows for easier motor alignment because the entire motor housing consists of two pieces.

To minimize the vertical height of the disposer, the exemplary disposer 100 uses a brushless permanent magnet (BPM) motor 116. In certain implementations, a 0.75 hp to 1.25 hp motor is sufficient. The aspect ratio of the BPM 116 motor is such that the motor height is small with respect to the motor diameter, which is comparatively large. The advantage of this aspect ratio is two-fold: The motor can produce high locked rotor torque because the magnetic field is acting on permanent magnets configured on a large diameter rotor. Secondarily, the large diameter rotor has high rotational energy when the disposer is operating at normal speeds. The high rotational inertia is important when grinding hard objects, such as, bones.

The motor 116 includes a rotor 210, a shaft 212, and a stator 214. The stator 214 is formed from a plurality of laminations and includes windings 216 situated around a plurality of stator teeth 218. The rotor 210 is formed from a plurality of laminations mounted on the rotor shaft 212. The shaft 212 has a lower end connected to a bearing mechanism 220 on a lower end frame of the motor section 112. The shaft 212 has an upper end that passes through a bearing/sealing mechanism 222 and connects to the rotating shredder plate 130 of the grinding mechanism 114 by a suitable fastener.

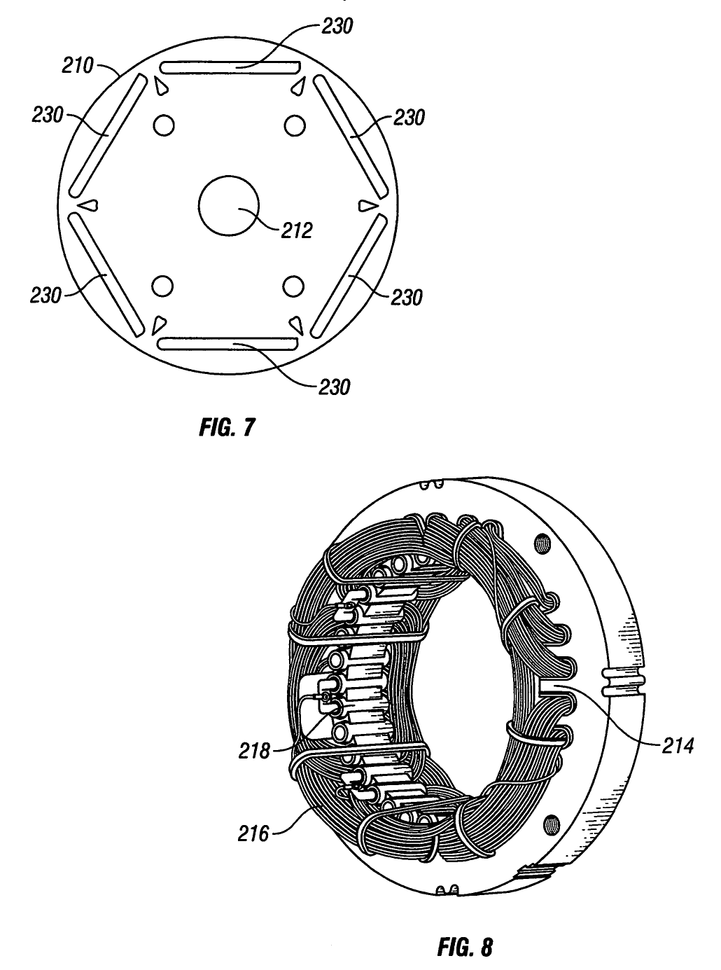

FIG. 7 and FIG. 8 illustrate an exemplary rotor 210 and stator 214, respectively. The rotor 210 has permanent magnets 230 placed into a core section as shown in FIG. 7. The core section is typically made of stacked laminations, but uses no die-casting or windings. Ferrite magnets have traditionally been used in the rotor 210. However, recent advances in materials have led to the use of neodymium-iron-boron magnets. These have energy levels five times greater than ceramic (ferrite) and allow the BPM motor 116 to be even more efficient and smaller. The magnets can be located in the rotor 210 as shown in FIG. 7, or in other embodiments, the magnets are attached to the outside of the rotor (i.e., as curved magnets).

A BPM motor uses electrical commutation eliminating the need for brushes. The rotor position must be known for an electrically commutated BPM to work, and in this regard the BPM can employ a rotor position sensor or a sensorless drive. For a BPM employing a position sensor, sensing devices such as Hall effect sensors can be used to determine rotor position. Alternatively, sensorless drives, which do not require position sensors, are also available. In these sensorless drives, the rotor position is determined by analyzing electrical aspects of the motor. In either approach, an electronic controller (motor drive) is required for this motor to properly sequence current to the various phases of the BPM.

A food waste disposer with a BPM motor, such as disclosed herein, has several advantages when compared with disposers employing other types of motors, such as switched reluctance motors, brushed permanent magnet motors, and an induction motors. Advantages include an overall smaller disposer size for comparable horsepower, which allows the BPM disposer to be smaller in vertical height (which frees up space under the sink) when compared with disposers employing these other types of motors. More specifically, the disclosed BPM motor for the disposer has a stator lamination height of approximately 0.4 inches, and a total stator height of approximately 1.5 inches. The BPM disposer also weighs less than such other disposer approaches, with the stator, rotor and shaft of the disclosed BPM weighing approximately 3.0 pounds. This lighter weight is beneficial for a food waste disposer because it makes BPM disposer installation easier and shipping cheaper when compared with disposers employing other types of motors. Additionally, BPM disposers use less electricity because the BPM motor has good efficiency, approximately 90 percent. Accordingly, electrical control circuitry need not be as large and as capable and handling high currents because the BPM motor's current draw is lower, easing motor control design and making the disposed cheaper to operate. Moreover, the BPM has higher starting torque when compared to comparable induction motors, which can eliminate jamming when the disposer is first started. Additionally, no centrifugal start switch is needed for a BPM as with induction motors, which adds undesirable height to an induction motor disposer.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

1. (canceled)

2. (canceled)

3. (canceled)

4. (canceled)

5. (canceled)

6. (canceled)

7. (canceled)

8. (canceled)

9. (canceled)

10. A food waste disposer, comprising:
a food conveying section;
a grinding mechanism;
and a brushless permanent magnet (BPM) motor operably connected to the grinding mechanism.

11. The food waste disposer of claim 10, wherein the BPM motor includes a rotor situated to rotate relative to a stator, the rotor including a plurality of magnets situated in a core section of the rotor.

12. The food waste disposer of claim 10, further comprising a discharge chamber, wherein the grind mechanism includes a shredder plate defining a plane, and wherein at least a portion of the discharge chamber is located above the plane.

13. The food waste disposer of claim 12, wherein the discharge chamber defines a discharge port, and wherein at least a portion of the discharge port is located above the plane.

14. The food waste disposer of claim 12, wherein the grind mechanism includes a grind ring, and wherein the discharge chamber and the grind ring define a gap therebetween.

15. The food waste disposer of claim 14, wherein a cross-sectional area of the gap increases from a first location to a discharge port defined by the discharge chamber.

16. The food waste disposer of claim 12, further comprising a plurality of lugs attached to the shredder plate.

17. (canceled)

18. (canceled)

19. (canceled)

20. (canceled)

21. The food waste disposer of claim 11, wherein the magnets are permanent magnets.

22. The food waste disposer of claim 11, wherein the BPM motor further comprises a shaft that has an upper end that passes through a bearing/sealing mechanism and connects to the grinding mechanism.

23. The food waste disposer of claim 11, wherein the stator is formed from a plurality of laminations and comprises windings situated around a plurality of stator teeth.
